(19) United States
(12) Patent Application Publication
(10) Pub. No.: US 2006/0008564 A1
(43) Pub. Date: Jan. 12, 2006

(54) Cholesterol-lowering batter-based food composition and method for making same

(76) Inventors: Wendy Miller Pzena, Short Hills, NJ (US); Norman Null III, Mount Laurel, NJ (US)

Correspondence Address: Ward & Olivo, 382 Springfield Avenue, Summit, NJ, 07901, US

(21) Appl. No.: 10/887,415

(22) Filed: Jul. 8, 2004

(51) Int. Cl. A21D 10/00

(52) U.S. Cl. 426/549

(57) ABSTRACT

Disclosed are batter-based baked goods which comprise oats, psyllium, and phytosterol esters. Also disclosed is a method for making these baked goods. The baked goods, preferably cookies, provide an effective method for lowering blood cholesterol levels in humans. The batter-based product of the present invention also provide an effective method for administering these cholesterol-lowering ingredients in a form which tastes good and makes it easier for a patient to consume sufficient quantities of soluble fiber and phytosterol esters.

### FIELD OF THE INVENTION

The present invention relates to batter-based food products for lowering blood cholesterol levels by combining oats, psyllium and phytosterols.

### BACKGROUND OF THE INVENTION

It is well known that high blood cholesterol (hypercholesterolemia) has been shown to be a significant risk factor for developing cardiovascular heart disease. Various factors affect a person's cholesterol level, including heredity, diet, weight, exercise, age, gender, stress-level, and alcohol consumption. While doctors may prescribe cholesterol-lowering drugs, most physicians also advise patients to alter their diets and lifestyles to aid in cholesterol-lowering. Various food additives have been shown to lower cholesterol, including oats, psyllium and phytosterols.

Research has shown that oats can lower blood cholesterol levels, especially low-density lipoprotein (LDL) levels. The soluble fiber found in oats contains beta-glucan. Adding beta-glucan in the form of oats to the diet has been shown to reduce blood cholesterol levels by up to 10% over time. However, when consumption of oats is ceased, blood cholesterol levels return to pre-oat consumption levels.

Another substance known to lower blood cholesterol is psyllium. Psyllium is a known mucilaginous material which is found in the seeds from the plants of the Plantago genus. The seeds are dark brown, smooth, boat-shaped and shiny. It is believed by those skilled in the art of food chemistry that the active ingredient of psyllium is the psyllium seed gum, which is located primarily in the seed husk. Therefore, ground seed husk is generally used as the source for psyllium when it is incorporated into foods. However, the whole seed is also known as a psyllium source, as well as the dehusked psyllium seed.

It is well known that psyllium decreases plasma triglycerides and LDL cholesterol, particularly in humans. Psyllium, which belongs to a class of gel-forming soluble fibers, disrupts the absorption or metabolism of cholesterol by binding, entrapping, absorbing, or otherwise interfering with the reabsorption of bile acids across the intestinal lumen. The soluble fiber interferes with the intraluminal formation of micelles, resulting in decreased cholesterol and bile acid reabsorption. The end result is that more bile acids and dietary cholesterol are ultimately excreted in the feces. When less dietary and biliary cholesterol is absorbed, less cholesterol is returned to the liver. This stimulates LDL receptor formation which, in turn, increases the hepatic uptake of LDL and thus decreases serum LDL cholesterol levels.

Due to the mucilaginous nature of psyllium, however, psyllium acquires a slimy or adhesive texture and mouthfeel upon hydration. This slimy mouthfeel is unpalatable and, accordingly, various additives have been incorporated in psyllium-containing ingestible compositions in order to mask the undesirable texture and mouthfeel of the psyllium. In addition, psyllium develops a distinctive, undesirable flavor in the presence of heat and moisture which has limited its use in food products to date.

In addition, the mucilaginous nature of psyllium husks (and of soluble fibers in general) presents grave processing difficulties. Difficulties notwithstanding, the desirable therapeutic effects provided by psyllium have led to many prior psyllium-containing formulations. Pre-wetted psyllium and an extruded psyllium nugget have been used to overcome processing difficulties associated with psyllium, as described, e.g., in U.S. Pat. Nos. 5,384,136; 5,384,144; and 5,223,298. Furthermore, various psyllium containing foods have been proposed which purport to take advantage of the natural digestion regulation properties of psyllium. See, for example, U.S. Pat. Nos. 3,574,634 and 4,348,379.

Prior attempts have been made to overcome the problems of using psyllium in ready-to-eat cereal and bakery products such as cookies. U.S. Pat. No. 5,227,248, hereby incorporated by reference, describes preparation of an extruded psyllium nugget that is incorporated into cereal and baked products such as cinnamon cookies.

Psyllium-containing snack foods are very desirable because snack foods provide consumers with a convenient, readily available food source that requires little or no preparation time. Various types of snack products are known in the art.

Phytosterol esters are yet another substance known for having cholesterol-lowering properties. These fat-like esters have similar physical characteristics as triglyceride fats, but are less readily digested or absorbed than the harmful triglyceride fats, such as saturated fats and trans-unsaturated fats.

It has been shown that using stanol or sterol fatty acid esters, or mixtures of these esters in foods have beneficial effects. Plant sterols and plant stanol esters, when added to the diet, have been shown to effectively lower the blood serum cholesterol level, especially LDL-cholesterol in humans, (see, for example, U.S. Pat. No. 5,502,045). According to the FDA, foods containing at least 0.65 grams per serving of plant sterols or 1.2 grams of plant stanol esters in two meals may reduce the risk of heart disease. Cholesterol levels can be reduced with a daily intake between about two and two and a half grams of stanol fatty acid esters calculated as free stanol. Results reported include a reduction in cholesterol levels up to 12%.

As discussed, oats, psyllium and phytosterol esters by themselves have been shown to reduce blood cholesterol levels. However, applicant is unaware of any previous art which addresses the synergistic effect of the combination of these three ingredients together in one product. A much greater effect is seen in the present invention than by consuming the ingredients individually, or even a combination of two of the ingredients. Thus, there is a clear need for a palatable product incorporating oats, psyllium and phytosterol esters.

In light of these apparent needs, it is an object of the present invention to provide a batter-based food including oats, psyllium and phytosterols, for lowering blood cholesterol levels.

It is another object of the present invention to provide a method for producing the cholesterol-lowering composition in the form of a batter-based food.

Yet another object of the present invention is to deliver cholesterol-lowering ingredients in a form which tastes good.

Another object of the present invention is to provide a method for easily ingesting sufficient quantities of oats, psyllium and phytosterol esters to lower cholesterol.

Other objects, features, and characteristics of the present invention, as well as the methods of operation and functions of the related elements of the structure, and the combination of parts and economies of manufacture, will become more apparent upon consideration of the following detailed description, all of which form a part of this specification.

### SUMMARY OF THE INVENTION

The present invention relates to batter-based foods which combine oats, psyllium and phytosterols and a method for making the same. Preferably, the batter-based goods comprise enough oats, psyllium and phytosterol esters to provide a cholesterol-reducing effect when ingested. This combination may be added or substituted to various types of batter before baking.

The oats are preferably present at least 11% by weight, psyllium is at least 13% by weight, and phytosterol esters are present at least 3% by weight. Further, each serving should contain at least five grams of fiber, with at least 3.5 grams coming from soluble fiber. The weight percentages are on a dry basis, i.e., the percent present in uncooked batter. Furthermore, foods cooked according to the present invention have excellent flavor and texture. A cholesterol-lowering effect results over a period of time when consuming the baked products according to the present invention on a regular basis.

### DETAILED DESCRIPTION OF THE INVENTION

As required, a detailed illustrative embodiment of the present invention is disclosed herein. However, techniques, systems and operating structures in accordance with the present invention may be embodied in a wide variety of forms and modes, some of which may be quite different from those in the disclosed embodiment. Consequently, the specific structural and functional details disclosed herein are merely representative, yet in that regard, they are deemed to afford the best embodiment for purposes of disclosure and to provide a basis for the claims herein which define the scope of the present invention. The following presents a detailed description of the preferred embodiment (as well as some alternative embodiments) of the present invention.

The present invention provides an effective method for incorporation of oats, psyllium, and phytosterol esters into a batter-based composition. For example, most conventional cookie recipes can be modified to fit the present invention, but chocolate chip cookies are especially preferred. Other batter-based goods can be made according to the present invention including, but not limited to waffles, pancakes, muffins, brownies, cakes, scones, crusts, and cereals.

The batter preferably comprises approximately 10-20% by weight psyllium husks powder, approximately 5-20% by weight oat flour, and approximately 0.65 grams per serving of plant sterols or 1.3 grams per serving plant stanols.

The batter-based goods of the present invention also comprise conventional ingredients typically found in such products, including flour, margarine, sugar, eggs, chocolate chips and the like.

Ordinary granulated sugars are satisfactory for use in making the batter-based products of the present invention. These include sucrose, dextrose, maltose, fructose, brown and invert sugars, alone or in combination. The preferred sugars are brown sugar and granulated white sugar. Corn syrup, a type of invert sugar, is also preferably included in the present invention, but other invert sugars can be used. Powdered sugars may also be used. Sugar substitutes, such as aspartame and sucralose, can be used with other sugars or as a substitute. The amount of sugar used in the composition is typical of conventional batter recipes, approximately 30% by weight of the dry composition. In a preferred embodiment of a cookie recipe, brown sugar is approximately 12%, white sugar is approximately 11%, and invert sugar is approximately 3% by weight of the cookie. The various sugars and mixtures thereof will be present at approximately 26% by weight of the batter.

In the batter of the present invention, psyllium husks powder cannot be completely substituted for the entire flour portion of the batter. The batter-based products of the present invention are preferably made with the psyllium husks powder, oat flour and a reduced level of white flower.

The flour for use in the present invention may be any finely comminuted meal of any cereal grain or edible seed, or mixture thereof, as known to one skilled in the art of baking. Typical examples include wheat flour, oat flour, barley flour, rye flour, cornstarch and corn flour, and other flours suitable for baking. Preferably the flour use in the present invention is a general purpose unbleached white flour. A cookie prepared according to the present invention may comprise approximately 25% flour, but preferably comprises approximately 15% flour.

Various fats are suitable for use in the present invention, including solid or plastic, as well as liquid or semifluid, glyceride shortenings derived from animal, vegetable fats and oils including synthetically prepared shortenings. These glycerides can contain saturated or unsaturated long-chain acyl radicals and are generally obtained from edible oils and fats such as corn oil, cottonseed oils, soybean oil, coconut oil, rapeseed oil, peanut oil, olive oil, palm oil, palm kernel oil, sunflower seed oil, safflower oil, lard, tallow and the like.

A preferred fat for use in the present invention is margarine, typically comprising partially hydrogenated soybean oil, water, salt, soy lechtin, vegetable mono and diglycerides, potassium sorbate, citric acid, artificial flavor, colored with beta carotene, and vitamin A palmitate.

The phytosterol esters used in the present invention comprise unsaturated and saturated fatty acid esters of sterols or stanols as well as mixtures thereof. The term “phytosterol” is intended to mean saturated and unsaturated sterol alcohols and their blends derived from plants (plant sterols), as well as synthetically produced sterol alcohols and their blends having properties that replicate those of naturally occurring alcohols. These sterol alcohols are characterized by a common polycyclic steroid nucleus comprising a 17 carbon atom ring system, a side chain and a hydroxyl group. The nucleus is either saturated, wherein the sterol alcohol is referred to as a stanol, or unsaturated, wherein the sterol alcohol is referred to as a sterol. For purposes of the present invention, sterol is understood to mean a single sterol or blends of sterols, and stanol is understood to mean a single stanol or blends of stanols.

The sterol or stanol is added to the edible food as a replacement for at least a portion of the harmful cholesterol raising fats. Phytosterols are also included in the fat component of the batter, preferably at approximately 1% by weight of a cookie prepared according to the present invention. However, the amount of plant sterols used in the batter is dependent on the serving size of the product. Each serving preferably includes 0.65-1.5 grams of plant sterols or 1.3-3 grams of plant stanols. Overall, the fat component is approximately 10% by weight of the batter-based food.

Another ingredient including in the batter-based composition of the present invention are eggs. Eggs are preferably included to impart flavor, richness and color to these food products. Fresh whole eggs are preferred. Alternatively, egg solids, particularly egg albumen or dried yolk, egg substitutes such as EggBeaters®, soy isolates, or other egg substitutes may also be used in combination or in place of whole eggs in the present invention. For example, a cookie dough prepared according to the present invention may comprise up to approximately 9% egg component, but preferably comprises approximately 6% by weight eggs.

Conventional additives useful in making batter-based products of the present invention may include leavening agents, flavors, flavor additives, colors, nutrients, antioxidants, and antimicrobial agents.

Preferably, the leavening agent for use in the present invention is baking soda, but other leavening agents may be used as known in the art. The leavening agent may comprise approximately 0.4-0.8% by weight of a cookie dough prepared according to the present invention, but preferably comprises approximately 0.5% of the composition.

Flavor additives suitable for the present invention may remain as whole pieces in the batter. For example, such additives include, but are not limited to, chocolate chips, butterscotch chips, peanut butter, fruit, fruit-flavored bits, raisins, various types of nuts, coconut and the like. Cereals may also be used, such as bran or oatmeal. The batter composition comprises up to 26% by weight of such flavor additives, but preferably comprises approximately 13% by weight.

Other flavor additives are suitable for use in the batter of the present invention, including spices such as cinnamon, mace, nutmeg, caraway, anise, allspice, poppy seed, coriander, ginger, cloves, fennel and salt. Flavorings such as banana, orange, lemon, mint or vanilla may also be appropriate. Preferably these flavors are included at up to 1% by weight of cookies formed according to the present invention. In a preferred embodiment, salt is present at approximately 0.3% and vanilla is present at about 0.3% by weight. In alternative embodiments, honey, molasses, peanut butter, and the like may also be included in the batter. The exact amounts and types of flavor additives depend on personal preference and the type of batter being prepared.

For example, a batter-based cookie of the present invention preferably comprises the ingredients and amounts as outlined in the table below.

| Ingredient | Percent by Weight |
|---|---|
| Unbleached white flour | 15% |
| Flavor additives | 13% |
| Psyllium Husks Powder | 13% |
| Margarine | 12.3% |
| Brown Sugar | 12% |
| White Sugar | 11% |
| Oat Flour | 11% |
| Eggs | 6% |
| Invert Sugar | 3% |
| Phytosterol Esters | 3% |
| Salt | 0.3% |
| Vanilla | 0.3% |
| Baking Soda | 0.5% |

The ingredients of the present invention are combined in such a way as is known to those of skill in the art of baking. An exemplary method of making cookies using the ingredients of the present invention is outlined below.

In one large bowl or other appropriate container, the dry ingredients are combined, including flour, oat flour, psyllium husks powder, baking soda and salt. In another bowl, the margarine, phytosterol esters, brown and white sugars and invert sugars such as corn syrup are beat together. Next, the eggs and vanilla are beat into the sugar-fat mixture. Then the flour mixture is mixed in, and finally the chocolate chips are stirred in. The batter is then cooked as is typical for the baked good. For example, if a chocolate chip cookie dough was prepared, then the batter is scooped onto cookie sheets and baked at 350-375° F. for up to 15 minutes, depending on the size of the cookies. Similarly, if a waffle batter was prepared, then waffles would be prepared in the conventional manner.

Cookies prepared according to the present invention are approximately 40 grams each. Each cookie comprises about 3.5 grams of soluble fiber (from psyllium and oat flour) and 0.65 grams of sterols. It has been shown that eating two cookies per day (approximately 80 grams of cookie) results in a decrease in cholesterol levels up to 30%. This significant decrease in cholesterol levels is believed greater than the reduction that can be achieved from eating psyllium, oats, and phytosterols individually, or in combination with only one of the remaining two ingredients.

While the present invention has been illustrated using a cookie composition, other batter-based goods are appropriate for incorporation of oat flour, psyllium, and phytosterols and lower cholesterol when consumed. Such examples include, but are not limited to waffles, pancakes, muffins, scones, cakes, brownies, crusts, cereals and the like. These baked goods are manufactured in a similar way as the modified cookie recipe as outlined above. For example, when making waffles, oat flour should be substituted for a portion of the flour component in a typical waffle recipe. Similarly, phytosterol esters are added with fat in a waffle recipe, as they are contained in a fat medium. A dose-specific amount of psyllium is added and does not replace flours.

While the present invention has been described with reference to one or more preferred embodiments, such embodiments are merely exemplary and are not intended to be limiting or represent an exhaustive enumeration of all aspects of the invention. The scope of the invention, therefore, shall be defined solely by the following claims. Further, it will be apparent to those of skill in the art that numerous changes may be made in such details without departing from the spirit and principles of the invention. It should be appreciated that the present invention is capable of being embodied in other forms without departing from its essential characteristics.

I claim:

1. A batter-based product comprising:
oats;
psyllium; and
phytosterol esters;
wherein said batter-based product contains greater than 3 grams of digestible fat.

2. A product according to claim 1, wherein said oats are present at least 11% by weight.

3. A product according to claim 1, wherein said oats are selected from the group consisting of oat flour, whole oats, oat bran, or mixtures thereof.

4. A product according to claim 1, wherein said psyllium is present at least 13% by weight.

5. A product according to claim 1, wherein said psyllium is present in the form of psyllium husk powder.

6. A product according to claim 1, wherein said phytosterol esters are present at least 3% by weight.

7. A product according to claim 1, wherein said batter-based product is selected from the group consisting of cookies, waffles, pancakes, muffins, scones, cakes, and brownies.

8. A product according to claim 1, wherein said batter-based product further comprises a flavor additive.

9. A method for making a batter-based product, comprising:
combining oats, psyllium and flour to form a first mixture;
combining phytosterol esters, fat, sweetener, and eggs to form a second mixture;
mixing said first and second mixtures to form a batter;
wherein said batter comprises greater than 3 grams of digestible fat;
adding flavor agents; and
cooking said batter to form a batter-based product.

10. A method according to claim 9, wherein said oats are present by at least 11% by weight.

11. A method according to claim 9, wherein said oats are selected from the group consisting of oat flour, whole oats, oat bran, or mixtures thereof.

12. A method according to claim 9, wherein at least five grams of said psyllium is present in a 40 gram serving of said batter-based product.

13. A method according to claim 9, wherein said psyllium is present in the form of psyllium husk powder.

14. A method according to claim 9, wherein at least 0.65 grams of said phytosterol esters are present in a 40 gram serving of said batter-based product.

15. A method according to claim 9, wherein said batter-based product is selected from the group consisting of cookies, waffles, pancakes, muffins, scones, cakes, and brownies.

16. A method according to claim 9, wherein said dough further comprises a flavor additive.

17. A method according to claim 9, wherein said first mixture further comprises one or more of the following: baking powder, salt and baking soda.

18. A method according to claim 9, wherein said second mixture further comprises one or more of the following: margarine, brown sugar, white sugar, invert sugar, and vanilla.
